(19) United States
(12) Patent Application Publication
(10) Pub. No.: US 2016/0356622 A1
(43) Pub. Date: Dec. 8, 2016

(54) Walking Guidance During Transit Navigation

(71) Applicant: Apple Inc., Cupertino, CA (US)

(72) Inventors: Christine B. McGavran, Pacifica, CA (US); Wesley Yue, Sunnyvale, CA (US); Christopher Y. Tremblay, San Jose, CA (US); Usama M. Hajj, San Francisco, CA (US); Yoon Jae Kim, San Francisco, CA (US); Nathaniel V. Kelso, San Francisco, CA (US); Aaron A. Reiner, Mountain View, CA (US); David Hodge, Mountain View, CA (US)

(21) Appl. No.: 14/869,691

(22) Filed: Sep. 29, 2015

Related U.S. Application Data
(60) Provisional application No. 62/172,218, filed on Jun. 7, 2015.

(51) Int. Cl. G01C 21/36; G01C 21/20

(52) U.S. Cl. CPC G01C 21/3667; G01C 21/20

(57) ABSTRACT

Some embodiments provide a navigation application that provides, as a device traverses a transit route, a transit navigation presentation that includes navigation instructions that specify navigation maneuvers associated with at least one walking portion and a set of transit vehicles. The navigation application also monitors the device's position along the transit route. The navigation application also, after determining that the device is on the walking portion of the transit route, automatically, and without user intervention, presents a walking-direction indicator to identify the orientation of the device with respect to a desired walking-navigation direction of the walking portion of the route.

### BACKGROUND

With proliferation of mobile devices such as smartphones, users are enjoying numerous applications of numerous kinds that can run on their devices. One popular type of such application is mapping and navigation applications that allow users to browse maps and get route directions. Despite their popularity, these mapping and navigation applications have shortcomings with their features that cause inconvenience to the users.

### BRIEF SUMMARY

Some embodiments of the invention provide a navigation application that in a novel way provides walking guidance during a transit navigation presentation that is provided by a device. In some embodiments, a transit navigation presentation provides navigation instructions that specify navigation maneuvers that use one or more transit vehicles (e.g., buses, rapid-transit train vehicles, commuter-rail vehicles, long-distance train vehicles, ferries, etc.) as the device traverses a transit route from a starting location to a destination location. The transit navigation presentation in some embodiments also includes walking instructions that provide directions to transit vehicles or from transit vehicles.

In some embodiment, the navigation application iteratively monitors the device's position along the transit route. When the navigation application determines that the device is on a particular walking portion of the transit route, the navigation application automatically, and without user intervention, presents a walking direction indicator to identify the orientation of the device with respect to the desired walking-navigation direction of the particular walking portion of the route. The walking-navigation direction of the particular walking portion may change one or more times as the device traverses this portion of the route. As the walking-navigation direction changes, the user of the device can properly orient himself/herself along the desired walking direction by aligning the walking-direction indicator with the desired walking direction.

In different embodiments, the application uses different types of walking-direction indicators. For instance, in some embodiments, the walking-direction indicator has a range indicator that provides a range of potential orientations of the device. The indicator provides such a range in some embodiments because in some situations the exact orientation of the device might be difficult to specify with a high degree of accuracy. This would be the case in some embodiments when the device uses a compass to determine its orientation and the compass is not perfectly calibrated at a particular time (e.g., as the device emerges from an underground rapid-transit vehicle). As the device moves, the device's compass in some embodiments automatically improves its calibration. In these embodiments, the range indicator of the walking-direction indicator narrows to identify a more specific range of device orientation.

The walking-direction indicator is different in other embodiments. For example, in some embodiments, the direction indicator appears as a compass that has two needles, a first needle that points to a fixed geographic direction (e.g., North or other geographic direction, such as South, East, West), and a second needle that points in the direction that specifies the orientation of the device with respect to the fixed geographic direction. In such embodiments, the user can properly orient himself/herself along the desired walking direction by aligning the walking-direction indicator with the desired walking direction. Other embodiments provide yet other types of walking-direction indicators.

In addition to, or instead of, providing a walking-direction indicator during the walking portion of a transit navigation presentation, the navigation application of some embodiments provides an option during the walking portion to switch from a transit navigation presentation to a walking navigation presentation. In some embodiments, the transit navigation presentation is one navigation mode that is optimally designed for a transit navigation experience, while the walking navigation presentation is another navigation mode that is optimally designed for a walking navigation experience. For instance, in some embodiments, the walking navigation presentation provides turn-by-turn guidance along junctures of the walking portion (e.g., a guidance experience that provides separate and distinct walking maneuver instructions at different junctures along the walking route), while the transit navigation presentation does not provide turn-by-turn guidance at walking junctures along the walking portion.

Hence, during a walking portion of the transit navigation route, the navigation application provides a user selectable option to switch to the walking navigation presentation in order to obtain a richer walking navigation experience (e.g., to obtain turn-by-turn walking navigation instructions). In some embodiments, the navigation application displays navigation banners to provide navigation instructions during a transit navigation presentation. In some of these embodiments, the application provides the option to switch to a walking navigation presentation during the transit navigation presentation as a selectable user-interface (UI) item in a navigation banner that it presents during a walking portion of the transit navigation presentation. The application provides this option in some embodiments through other mechanisms, such as voice input instructions that (through a speech recognition interface of the device) direct the navigation application to switch from the transit navigation presentation to a walking navigation presentation.

In some embodiments, once the device reaches the end of a walking portion of the transit route, the navigation application automatically switches back to the transit navigation presentation, or automatically removes the walking-direction indicator, when the user still has one or more additional transit navigation maneuvers that he or she has to make (i.e., one or more transit vehicles that he or she has to take).

The preceding Summary is intended to serve as a brief introduction to some embodiments of the invention. It is not meant to be an introduction or overview of all-inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF DRAWINGS

The novel features of the invention are set forth in the appended claims. However, for purposes of explanation, several embodiments of the invention are set forth in the following figures.

FIGS. 1 and 2 illustrate the transit navigation presentation of some embodiments.

FIG. 3 illustrates an example of a walking-direction indicator.

FIG. 4 illustrates an example of how the walking-direction indicator in some embodiments displays a range of orientations that dynamically narrows as the device moves and improves its compass calibration.

FIGS. 5 and 6 illustrate two alternative representations for walking direction indicator

FIG. 7 illustrates a process that the map application of some embodiments uses to display a walking-direction indicator during a walking portion of a transit route.

FIG. 8 illustrates an example of how the map application of some embodiments provides a walking-navigation option during the walking portion of a transit navigation presentation.

FIG. 9 conceptually illustrates a process that describes the operation of the map application of some embodiments during the walking portion of a transit navigation presentation.

FIG. 10 illustrates several modules of the map application of some embodiments of the invention.

FIG. 11 is an example of an architecture of a mobile computing device.

FIG. 12 conceptually illustrates another example of an electronic system with which some embodiments of the invention are implemented.

FIG. 13 illustrates one possible embodiment of an operating environment for a map service and client devices.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a navigation application that in a novel way provides walking guidance during a transit navigation presentation that is provided by a device. In some embodiments, a transit navigation presentation provides navigation instructions that specify navigation maneuvers that use one or more transit vehicles (e.g., buses, rapid-transit train vehicles, commuter-rail vehicles, long-distance train vehicles, ferries, etc.) as the device traverses a transit route from a starting location to a destination location. The transit navigation presentation in some embodiments also includes walking instructions that provide directions to transit vehicles or from transit vehicles.

In some embodiment, the navigation application iteratively monitors the device's position along the transit route. When the navigation application determines that the device is on a particular walking portion of the transit route, the navigation application automatically, and without user intervention, presents a walking direction indicator to identify the orientation of the device with respect to the desired walking-navigation direction of the particular walking portion of the route. The walking-navigation direction of the particular walking portion may change one or more times as the device traverses this portion of the route. As the walking-navigation direction changes, the user of the device can properly orient himself/herself along the desired walking direction by aligning the walking-direction indicator with the desired walking direction.

In addition to, or instead of, providing a walking-direction indicator during the walking portion of a transit navigation presentation, the navigation application provides an option during the walking portion to switch from a transit navigation presentation to a walking navigation presentation. In some embodiments, the transit navigation presentation is one navigation mode that is optimally designed for a transit navigation experience, while the walking navigation presentation is another navigation mode that is optimally designed for a walking navigation experience. For instance, in some embodiments, the walking navigation presentation provides turn-by-turn guidance along junctures of the walking portion (e.g., a guidance experience that provides separate and distinct walking maneuver instructions at different junctures along the walking route), while the transit navigation presentation does not provide turn-by-turn guidance at walking junctures along the walking portion.

Hence, during a walking portion of the transit navigation route, the navigation application provides a user selectable option to switch to the walking navigation presentation in order to obtain a richer walking navigation experience (e.g., to obtain turn-by-turn walking navigation instructions). In some embodiments, once the device reaches the end of a walking portion of the transit route, the navigation application automatically switches back to the transit navigation presentation, or automatically removes the walking-direction indicator, when the user still has one or more additional transit navigation maneuvers that he or she has to make (i.e., one or more transit vehicles that he or she has to take).

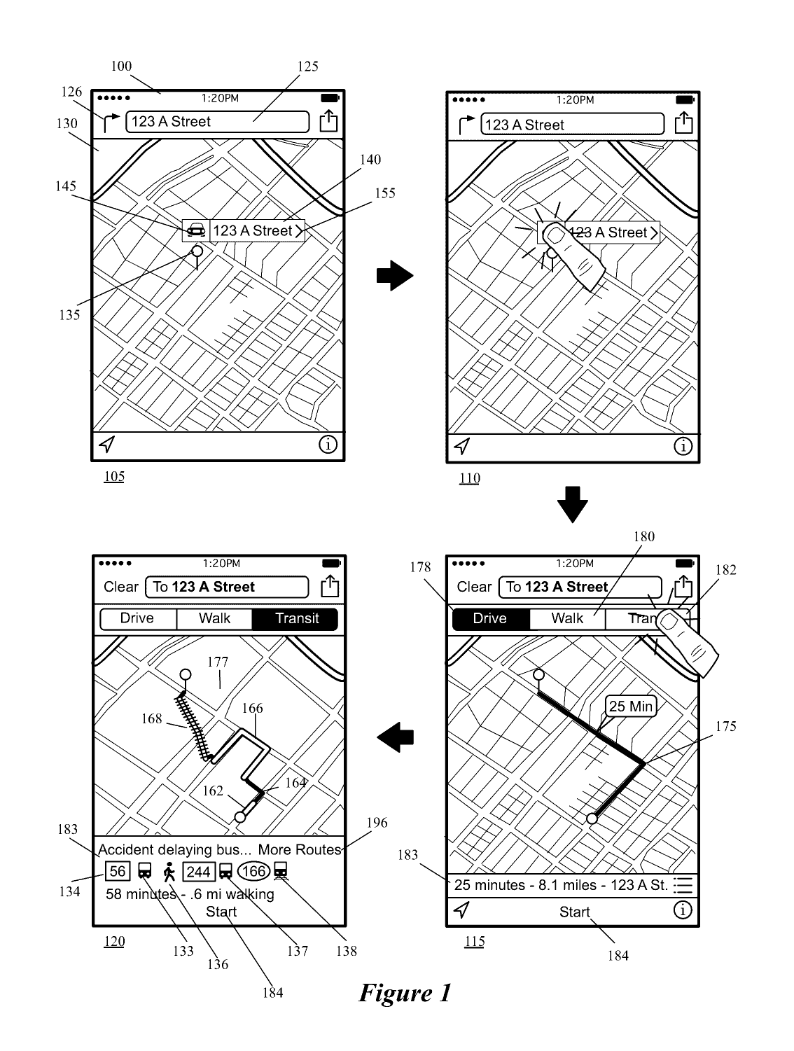

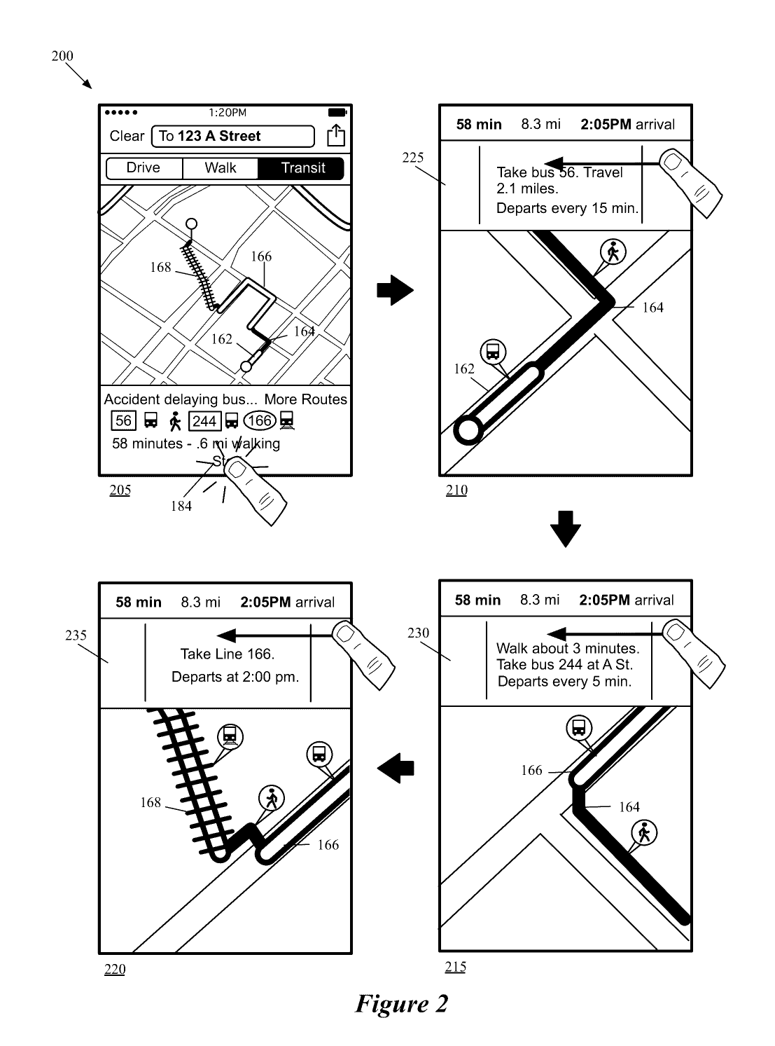

Before describing the walking-direction indicator and walking navigation-presentation option of some embodiments further, the transit navigation presentation of some embodiments will first be described by reference to FIGS. 1 and 2. FIG. 1 illustrates a map application that provides transit navigation presentations of some embodiments of the invention. In some embodiments, the map application executes on a mobile device (e.g., a smartphone, a tablet, a laptop, etc.) with a touch-sensitive display screen. The map application can operate in a map-browsing mode to allow a user to browse a map of a locality and to perform searches for map locations based on addresses, names (e.g., people, businesses, etc.) or other search parameters. It also has a navigation mode that includes a driving navigation mode to provide driving navigation directions, a walking navigation mode to provide walking navigation directions, and a transit navigation mode to provide transit navigation directions.

FIG. 1 illustrates how the transit navigation mode of the map application can be selected. To do this, it presents four operational stages 105-120 of the user interface (UI) 100 of the map application. The first stage 105 illustrates a search box 125, a map presentation area 130 of a geographical area, a pin 135, and a banner 140. In the search box 125, a user can enter a search parameter to search for a particular location for display in the map presentation area 130. In some embodiments, the search parameter can be an address or name of an entity (e.g., a business, organization, person, etc.), or some other parameter.

When the map application can identify one or more locations for search parameter that it receives, the map application in some embodiments (1) displays in the presentation area 130 a map that displays some or all of the identified locations, and (2) displays a pin 135 or other location indicator for each displayed location to identify the position of the identified location. Also, in some embodiments, the map application a banner 140 over one of the pins 135 to provide access to more information about the location identified by the pin. The banner also provides some information about the identified location.

In the example illustrated in the first stage 105, the user has entered an address (123 A Street) in the search box 125. As a result, the application displays the map in the area 130 that represents geographical area that includes the entered address. This stage also shows that the application further displays (1) the pin 135 over the map presentation to identify the location of the entered address on the map and (2) the banner 140 over the pin. As shown, this banner includes the address “123 A Street,” and includes a selectable control 155, which when selected causes the map application to present a display area (e.g., a placecard) that provides more information about the identified location.

The banner also includes a selectable route control 145 that, in this example, is depicted as a car. As shown in the second and third stages 110 and 115, the selectable route control 145 can be selected (e.g., by touch selection of the control 145) to direct the map application to provide a route-overview presentation that displays a route from the device's current location to the address that is associated with the banner (i.e., to the searched 123 A Street address).

The third stage 115 shows that the displayed route 175 is laid over the region map, which is the same map that is displayed in the first and second stages 105 and 110. The third stage 115 also shows three navigation mode controls, which are the driving mode control 178, the walking mode control 180, and the transit mode control 182. Through these controls, the user can direct the map application to provide one or more driving routes, walking routes, and transit routes from the device's current location to the specified destination (i.e., to 123 A Street in this example).

The third stage 115 shows the driving mode control 178 highlighted to indicate that the route 175 that the application initially provides is a driving route. In some embodiments, the map application dynamically determines whether to provide an initial driving, walking or transit route based on the distance to the destination, the locality in which the device currently operates, and the detected current mode of transportation for the device (if any). The map application makes this dynamic determination based on a set of rules that specify the default mode of navigation under different detected conditions. This approach is further described in concurrently filed U.S. patent application entitled “Map Application with Transit Navigation Mode,” with the attorney docket number APLE.P0652.

The third stage also shows that for the displayed route, the map application provides information about the route in a display area 183. For instance, in the driving mode, the display area 183 displays the driving distance and duration to the destination from the current location of the device. The third stage also shows that the route-overview presentation includes a start control 184 for starting a turn-by-turn navigation experience to the destination based on the currently selected navigation mode (e.g., driving mode, walking mode, or transit mode).

The third stage shows that the user selecting the transit control 182 (e.g., by tapping on 182) to change the navigation mode of the application from a driving navigation mode to transit navigation mode. Upon receiving this request, the map application of some embodiments identifies one or more transit routes to the specified destination, selects one of the identified transit routes as the best possible transit route based on a set of criteria, and displays the selected transit route 177, as shown in the fourth stage 120.

Specifically, to identify the transit routes, the application of some embodiments examines trips that one or more transit vehicles of one or more transit systems make from locations nearby the current device location to locations near the specified destination. Based on this examination, the application identifies one or more transit routes that start near the device's current location and end near the specified destination. These identified routes can use one or more transit vehicles of one or more transit systems in some embodiments. After identifying the transit routes, the map application then selects one of the identified transit routes based on a set of criteria (e.g., fastest route, shortest route, route with least amount of walking, route requiring least amount of transit vehicle changes, route requiring least amount of transit system changes, etc.), and displays this identified route over the map displayed in the area 130. In some embodiments, the selection criteria set relies on two or more selection parameters. Also, in some embodiments, the selection criteria set is different in different transit markets and/or in different periods in the same transit market.

In some embodiments, the map application uses different representations for different portions of a displayed transit route that use different transit vehicles or require walking. For instance, the transit route 177 of the fourth stage 120 includes four portions, a first portion 162 that is traveled by bus, a second portion 164 that is a walking portion, and third portion 166 that is a traveled by another bus, and a fourth portion 168 that is traveled by subway. As shown, the map application uses different representation to differentiate the walking, bus, and subway portions from each other. In the discussion below, a transit leg refers to a portion of transit route that starts or ends with a transit maneuver that requires a transit vehicle change or a start or end of a walking portion of the transit route.

The fourth stage 120 shows that the display area 183 provides several different types of information for the displayed transit route. As shown, this display area identifies the transit vehicle type and the transit lines that are part of the displayed transit route. For this example, the display area 183 shows a bus 133 of a bus line 134 that travels the first portion 162 of the displayed transit route 177, a person 136 that identifies the second portion 164 as a walking portion, another bus 137 that travels the third portion 166, and a subway train 138 of subway line 168 that travels the fourth portion of the route. The display area also provides the overall duration of travel and the required walking distance. In some embodiments, the display area includes other data, such as time of departure, or frequency of travel.

The fourth stage 120 that the transit route-overview presentation also includes a More Routes control 196 and the Start control 184. Selection of the More Routes control 196 directs the map application to provide additional transit routes to the specified destination. As described in the above-identified concurrently filed application, the map application in some embodiments presents the additional transit routes on another page.

FIG. 1 illustrates only one way that the map application of some embodiments can provide a transit route overview presentation. In some embodiments, the map application provides several other ways for a user to request an overview of a transit route. These include using a direction control 126 (that is shown in the first stage 105) to provide two locations between which the use wants to see a transit route.

When the map application is displaying a transit route overview presentation (like the one shown in the fourth stage 120 of FIG. 1), the selection of Start control 184 directs the map application to start a turn-by-turn transit navigation presentation that provides transit navigation directions from the device's current location to the destination. FIG. 2 illustrates an example of such a transit navigation presentation in terms of four operational stages of map application UI 200. The first stage 205 shows the user selecting the Start control 184. This stage is similar to the fourth stage 120 of FIG. 1, except that now the user is selecting the Start control 184.

The second stage 210 shows the initiation of the turn-by-turn transit navigation presentation after selection of the Start control 184. As shown, the transit navigation presentation in some embodiments includes one or more navigation banners and one or more maneuver map views. Each navigation banner corresponds to one maneuver map view. Each maneuver map view and its associated navigation banner provide pictorial and text description to describe a transit navigation maneuver, which typically is associated with a transit vehicle change or a start or end of a walking portion of the transit route. When the device's location is within one or more of the maneuver map views, the map application of some embodiments displays the device's location on the view(s) so that the user can orient him/herself with the required transit navigation maneuvers.

As shown by the second-fourth stages 210-220, the user of the device can swipe through the instruction banners to see successive transit navigation maneuver views along the transit route. Specifically, the second stage 210 shows the first bus portion 162 of the transit route 177, the third stage 215 shows the walking portion 164 of the route 177, and the fourth stage 220 shows the second bus portion 166 of the route 177. As shown, the walking portion 164 is presented after the user swipes the maneuver banner 225 in the second stage, and the second bus portion 166 is presented after the user swipes the maneuver banner 230 in the third stage.

The banner in each of these stages describes the associated transit maneuver and provides some information about this maneuver. For instance, (1) the second stage banner 225 describes the distance traveled by the first bus and the frequency of its departures, (2) the third stage banner 230 describes the amount of required walking (in terms of time and/or distance), the transit vehicle for the next leg, the frequency of departures of this vehicle, and (3) the fourth stage banner 235 the transit vehicle for the next leg and the departure time for this vehicle. One of ordinary skill will realize that in other cases the transit maneuver banners provide other information. In some embodiments, the map application detects the device's location along the navigated transit route and automatically steps through the transit navigation banners and their associated map views. One such auto-stepping approach is described in the above-mentioned concurrently filed application.

As mentioned above, the map application of some embodiments displays the device's location on one or more maneuver map views in the transit navigation presentation, to help the user orient him/herself with the required transit navigation maneuvers. To further assist with the walking portion of the transit navigation, the map application of some embodiments (1) detects when the device is on a walking portion of the transit route and (2) presents walking-direction indicator to the user can use to align himself/herself with the direction of travel for the walking portion.

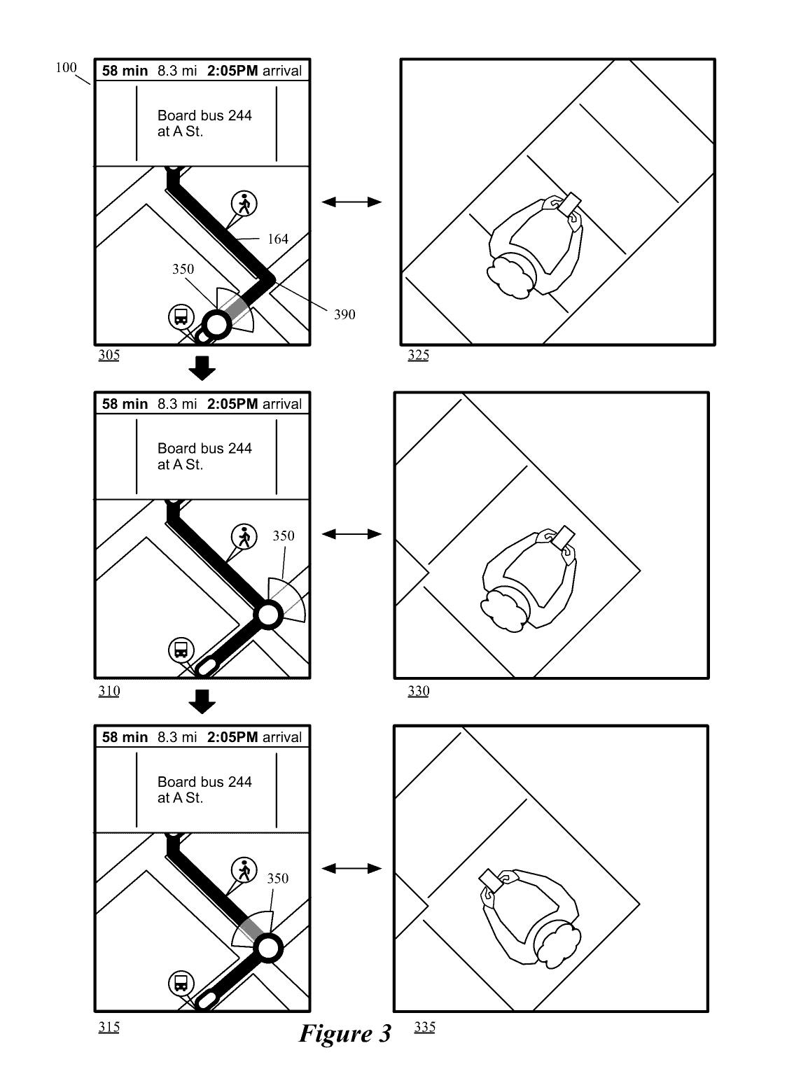

FIG. 3 illustrates an example of one such walking-direction indicator for the transit-route example that was described above by reference to FIGS. 1 and 2. This example is provided for the walking portion 164 of the transit route 177. This example is described in terms of three operational stages 305-315 of the map application UI 100 and three top-down views 325-335 of the device in the region that illustrates the positions and orientations of the device during three operational stages 305-320.

In the first stage 305, the device is off the bus that traversed the first portion 162 of the transit route 177. The map application has detected that the device is off the bus and is on the walking portion 164 of the route 177. In some embodiments, the map application can detect that a device is on a walking portion of a navigated transit route based on the identified location of the device and based on output data from the device's motions sensors that corresponds to the device being with a person who is walking and not driving. This detection will be further described below.

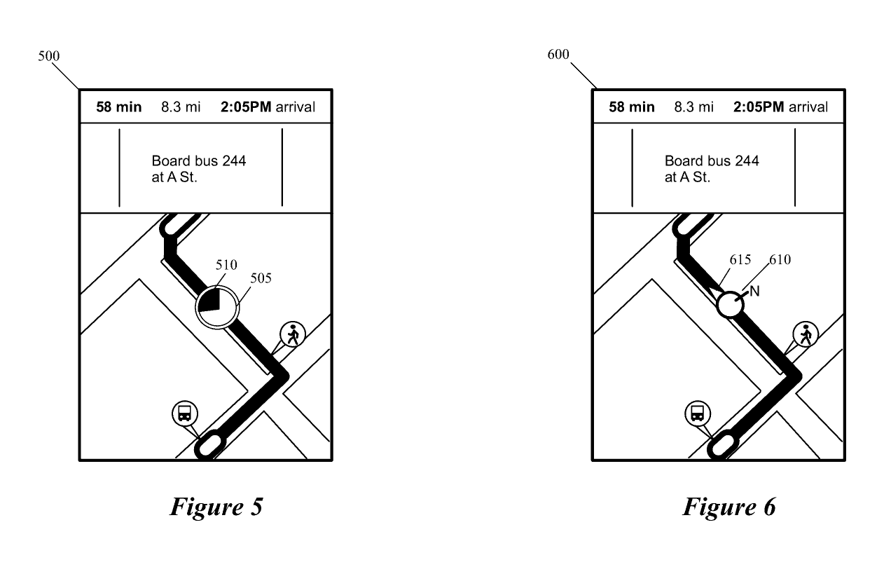

The first stage 305 shows a walking-direction indicator 350 that the map application presents in the displayed map portion view at the detected location of the device. In some embodiments, the map application automatically presents (without user intervention) the walking-direction indicator 350 once it detects that the device is on the walking portion 164 of the route 177. This indicator appears as a flashlight that specifies a light range that represents a range of potential orientations of the device. As further described below by reference to FIGS. 5 and 6, the walking-direction indicator appears differently, and uses different range indicators, in other embodiments.

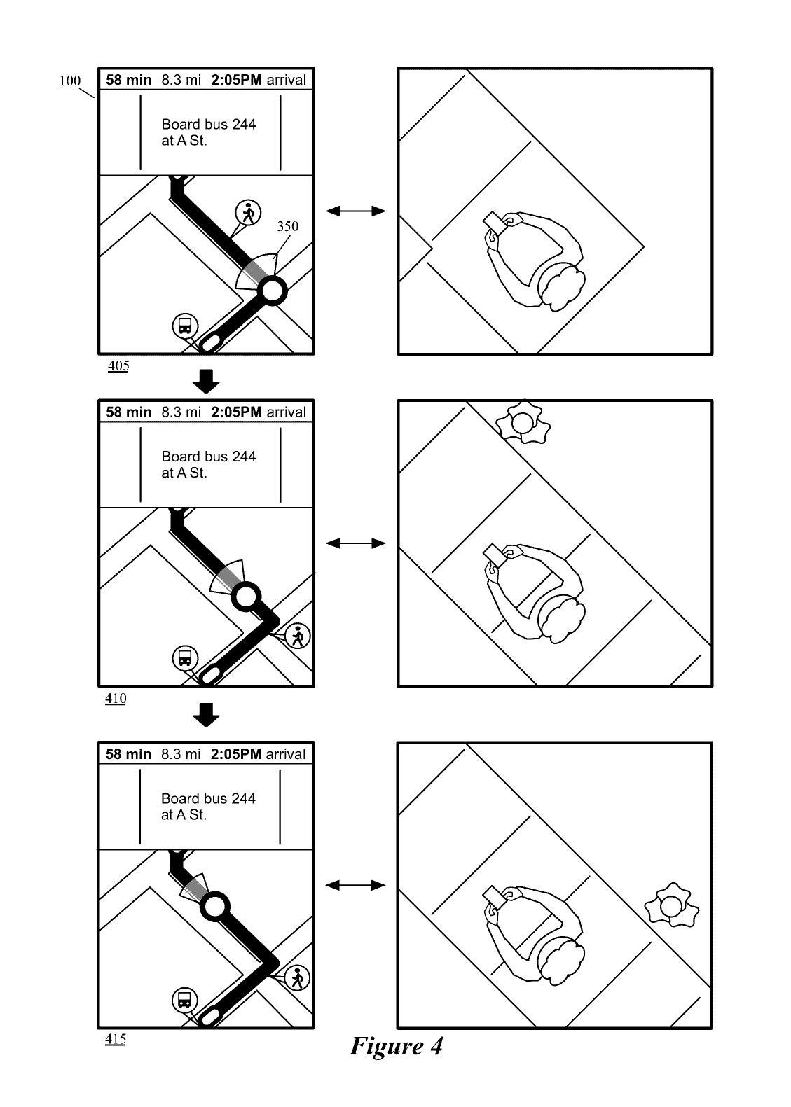

The light range indicator 350 provides a device-orientation range in some embodiments because in some situations the exact orientation of the device might be difficult to specify with a high degree of accuracy. This would be the case in some embodiments when the device uses a compass to determine its orientation and the compass is not perfectly calibrated at a particular time (e.g., as the device emerges from an underground rapid-transit vehicle). As the device moves, the device's compass in some embodiments automatically improves its calibration. In these embodiments, the range indicator of the walking-direction indicator narrows to identify a more specific range of device orientation, as further described below by reference to FIG. 4.

In the first stage 305, the device's orientation is aligned with the initial walking direction of the walking portion 164 of the transit route 177. This is indicated in both the top-down view 325, which shows the top of the mobile device pointing along the direction of travel, and in the first operational stage 305, which shows the light range indicator surrounding the initial portion of the walking leg 164.

The second stage 310 shows the device after it has reached a juncture 390 in the walking leg 164 of the transit route 177. In this stage, the device is still pointing along its previous orientation as indicated in the top-down view 330 of this stage. Hence, in the second operational stage 310, the walking-direction indicator's range does not overlap with the next segment of the walking leg 164.

Because of this misalignment, the user will know that the device is not pointing in the desired walking direction. By turning the device left, the user can as have the walking-direction indicator's range overlap with the next segment of the walking leg, as shown by the third operational stage 315. This overlap provides guidance feedback to the user that the device is now aligned with the desired walking direction.

FIG. 4 illustrates an example of how the walking-direction indicator in some embodiments displays a range of orientations that dynamically narrows as the device moves and improves its compass calibration. This example is illustrated in terms of three operational stages 405-415 of the map application UI 100. These stages show the device moving along a long walking portion of a transit route, and the range indicator 350 successively narrowing because the compass partially improves its calibration as the device moves along the route. It should be noted that automatic improvement to the compass calibration is not limited to the device's movement along a walking portion of the transit route. The compass can also improve its calibration as it moves on some transit vehicle (such as buses, or rail vehicles that do not go underground).

In the examples illustrated in FIGS. 3 and 4, the walking-direction indicator is in a form of a flashlight. One of ordinary skill will realize that this indicator is depicted in other forms in other embodiments. FIGS. 5 and 6 illustrate two alternative representations for this indicator. FIG. 5 illustrates a UI 500 that shows a walking-direction indicator 505 is in the form of a circle that identifies the location of the device and a circle sector 510 that identifies a range that the device's compass associates with the possible directions of the device. In some embodiments, this sector narrows as the calibration of the device's compass improves with the movement of the device.

FIG. 6 illustrates another style of walking-direction indicator in UI 600. In this example, the direction indicator again is placed at the current location of the device. However, in this example, the direction indicator appears as a compass that has two needles, a first needle 610 that points to a fixed geographic direction (e.g., North or other geographic direction, such as South, East, West), and a second needle 615 that points in the direction that specifies the orientation of the device with respect to the fixed geographic direction. In such embodiments, the user can properly orient himself/herself along the desired walking direction by aligning the walking-direction indicator with the desired walking direction. This approach works well for devices with compasses that are well calibrated and stay well calibrated. Other embodiments provide yet other types of walking-direction indicators.

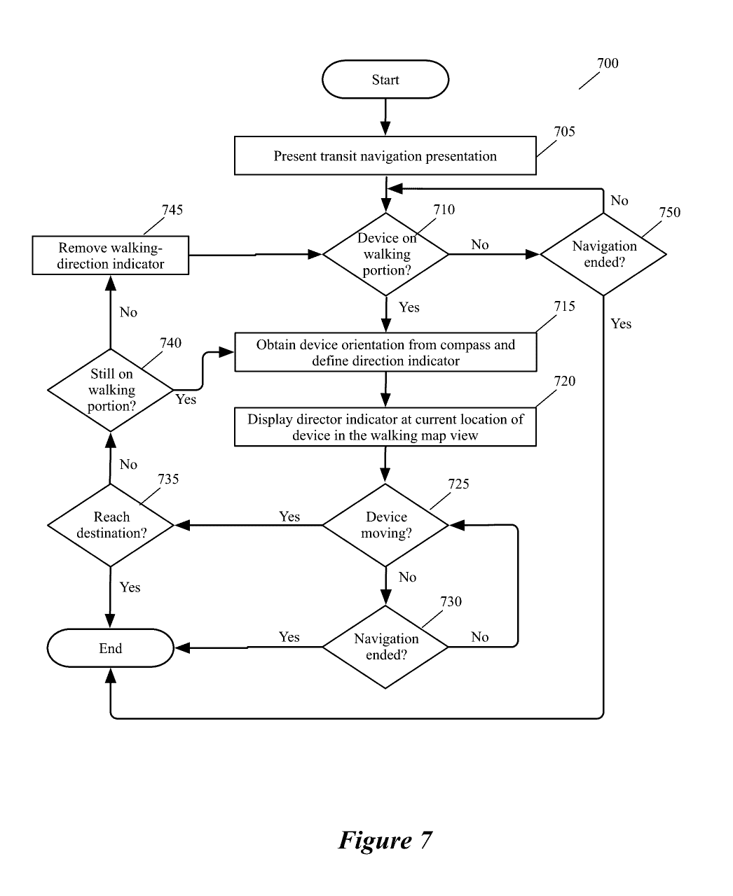

FIG. 7 illustrates a process 700 that the map application of some embodiments uses to display a walking-direction indicator during a walking portion of a transit route. The process 700 starts each time the map application commences a transit route navigation process. In some embodiments, the process 700 is a separate process that runs concurrently with the transit route navigation process in order to provide walking-direction indicator(s) during the walking portion(s) of a navigated transit route. In other embodiments, the process 700 is a sub-routine within the transit route navigation process.

As shown, the process initially presents (at 705) the first stage of a transit navigation presentation. Next, the process determines (at 710) whether the device is on a walking portion of the navigated transit route. The process 700 makes this determination differently in different embodiments. For instance, in some embodiments, the process 700 makes this determination by identifying the location of the device by using a location service of the device and correlating this identified location to a location on the navigated transit route. The location service of the device in some embodiments derives the device's location from sensor data that it obtains from one or more device sensors, such as the device's GPS (global positioning system) sensor, WiFi sensor, etc.

As location data can be inaccurate in some circumstances, the process 700 in some embodiments also relies on device motion sensor data to ensure that the device is on a walking portion of the transit route. The device in some embodiments has a motion service that analyzes data from various device motion sensors to formulate predictions about the device's current mode of movement (e.g., walking, driving, biking, etc.). These motion services are further described in U.S. Published Patent Application 2014/0365803A1, filed on Jun. 7, 2013, which is incorporated herein by reference. To further improve its prediction that the device is on a walking portion of a transit route, the process 700 uses a set of distance and direction rules to ensure that the device has reached and passed the end of the prior transit vehicle stage of the transit route. For instance, in some embodiments, the process may employ a distance rule that specifies that the walking-direction indicator should not be displayed when the device is within 50 feet from the end of the prior transit vehicle stage. The process may also employ one or more direction rules that specify that the walking-direction indicator should only be displayed if the device's direction of movement from the last transit-vehicle stop satisfies one or more direction-based criteria.

When the process determines (710) that the device is not on the walking portion of the transit route, the process determines (at 750) whether the device has reached the destination of the route. If so, the process ends. Otherwise, the process returns to 710. When the process determines (at 710) that the device is on a walking portion of the route, the process obtains (at 715) the device's orientation data from one or more sensors of the device. In some embodiments, the process obtains this data from the device's electronic compass. At 715, the process also defines a walking-direction indicator that specifies the orientation of the device while the device is on the walking portion. As mentioned above, the device's compass might not be perfectly calibrated in some situations (e.g., as the device emerges from an underground subway station). Because of this, the walking-direction indicator specifies a range of device orientations to signify the degree of inaccuracy in the compass data. As the device moves and the compass further calibrates because of this movement, the indicator-provided range narrows to signify the higher confidence in the compass' direction data.

After 715, the process directs (at 720) the transit navigation process to display the walking-direction indicator at the location of the device on the map view for the current walking leg of the transit route. Next, at 725, the process determines whether the device has moved. If not, the process determines (at 730) whether the transit navigation has ended (e.g., whether the user has terminated the transit navigation presentation). When the process determines (at 730) that the transit navigation has ended, the process ends. Otherwise, the process returns to 725 to determine again whether the device has moved.

When the process determines (at 725) that the device has moved, the process determines (at 735) whether the device has reached its destination. If so, the process ends. Otherwise, the process determines (at 740) whether the device is still on a walking portion of the transit route. When the device is no longer on a walking portion of the transit navigation, the process 700 directs (at 745) the transit navigation process to remove the walking-direction indicator and then returns to 710. On the other hand, when the process determines (at 740) that the device is still on the walking portion, the process returns to 715 to obtain new device orientation data and to update the walking-direction indicator definition.

In addition to, or instead of, providing a walking-direction indicator during the walking portion of a transit navigation presentation, the map application of some embodiments provides an option during the walking portion to switch from a transit navigation presentation to a walking navigation presentation. In some embodiments, the transit navigation presentation is one navigation mode that is optimally designed for a transit navigation experience, while the walking navigation presentation is another navigation mode that is optimally designed for a walking navigation experience. For instance, in some embodiments, the walking navigation presentation provides turn-by-turn guidance along junctures of the walking portion (e.g., a guidance experience that provides separate and distinct walking maneuver instructions at different junctures along the walking route), while the transit navigation presentation does not provide turn-by-turn guidance at junctures along the walking portion.

During a walking portion of the transit navigation route, the map application of some embodiments provides a user selectable option to switch to the walking navigation presentation in order to obtain a richer walking navigation experience (e.g., to obtain turn-by-turn walking navigation instructions). In some embodiments, the map application displays navigation banners to provide navigation instructions during a transit navigation presentation. In some of these embodiments, the application provides the option to switch to a walking navigation presentation during the transit navigation presentation as a selectable user-interface (UI) item in a navigation banner that it presents during a walking portion of the transit navigation presentation. The application provides this option in some embodiments through other mechanisms, such as a voice input instruction that (through a speech recognition interface of the device) directs the map application to switch from the transit navigation presentation to a walking navigation presentation.

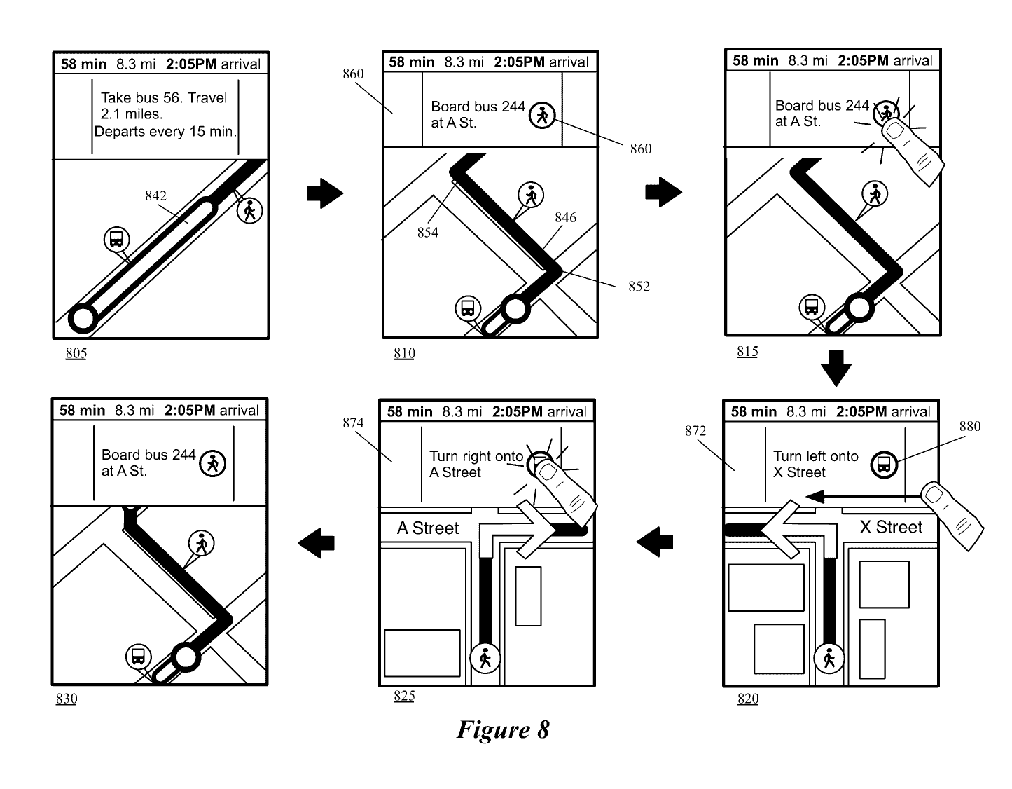

FIG. 8 illustrates an example of how the map application of some embodiments provides a walking-navigation option during the walking portion of a transit navigation presentation. This example is illustrated in terms of six operational stages 805-830 of the map application UI 100 of some embodiments. The first stage 805 shows the device on a first leg 842 of a transit route that uses a bus to reach a bus stop. The second stage 810 shows the device on a second leg 846 of the transit route. This leg 846 is a walking portion that involves two walking maneuvers at two junctures 852 and 854 along the walking portion.

As described above, each leg of the transit route is presented in the transit navigation presentation with a map view and a navigation banner. The navigation banner for each leg describes the navigation maneuver that the user has to perform in that leg. In the second stage 810, the navigation banner 860 includes a UI control 860 that when selected directs the map application to switch from a transit navigation presentation to a walking navigation presentation. In some embodiments, the map application includes this UI control as a static part of the navigation banner 860, while in other embodiments, the map application presents this UI control dynamically a time period after the device is on the walking leg 846 of the transit route.

The third stage 815 shows the user selecting the UI control 860. This selection directs the map application to switch from the transit navigation presentation that is provided in the first and second stages 805-810 to the walking navigation presentation that is illustrated in the fourth stage 820. In some embodiments, the walking navigation presentation has a different appearance than the transit navigation presentation. In some of these embodiments, the walking navigation presentation uses a map presentation that is optimally defined to accentuate map features (e.g., streets, alleys, pedestrian walkways, buildings, etc.) that assist the user to best understand the walked route and the walking environment, while the transit navigation presentation uses a different map presentation that is optimally defined to accentuate map features (e.g., transit lines, streets, buildings, etc.) that assist the user to best understand the transit route and the transit environment. The walking navigation presentation of some embodiments is further described in U.S. Patent Publication 2014/0365113A1, which is incorporated herein by reference. The transit navigation presentation of some embodiments is further described in the concurrently filed U.S. patent application entitled “Map Application with Transit Navigation Mode,” with the attorney docket number APLE.P0652, which is incorporated herein by reference.

While the transit navigation presentation in some embodiments does not provide turn-by-turn guidance at junctures along the walking portion, the walking navigation presentation provides turn-by-turn guidance along the walking portion. In FIG. 8, the walking navigation presentation provides a guidance experience that includes two navigation banners 872 and 874 that provide two walking maneuver instructions at two walking junctures 852 and 854 along the walking portion 846, as shown in fourth and fifth stages 820-825 of FIG. 8.

The transit navigation presentation of the second stage 810 does not provide separate maneuver banners for each of these two walking junctures, but rather describes the entire walking portion 846 by reference to one banner. As shown in the fourth and fifth stages 820-825, the user can scroll through the walking navigation banners (1) to read about the walking maneuver that the user has to perform at each of the two walking junctures 852 and 854 along the walking portion 846, and (2) to see each of these maneuvers on the map view that is presented with each of the navigation banners. In some embodiments, the map application automatically scrolls from a first walking navigation banner (e.g., banner 872) to a second walking navigation banner (e.g., banner 874) when it detects that the device has moved past the juncture that was associated with the first banner.

As shown in the fourth and fifth stages 820 and 825, each walking navigation banner 872 or 874 of the walking portion 846 has a UI control 880 for switching from the walking navigation presentation back to the transit navigation presentation. The fifth stage 825 shows the user selection of this control 880. This selection causes the map application to switch back to the transit navigation presentation, as shown in the sixth stage 830. In some embodiments, the map application automatically switches back to the transit navigation presentation when it detects that the device has reached the end of the walking portion of a transit route that has not yet ended.

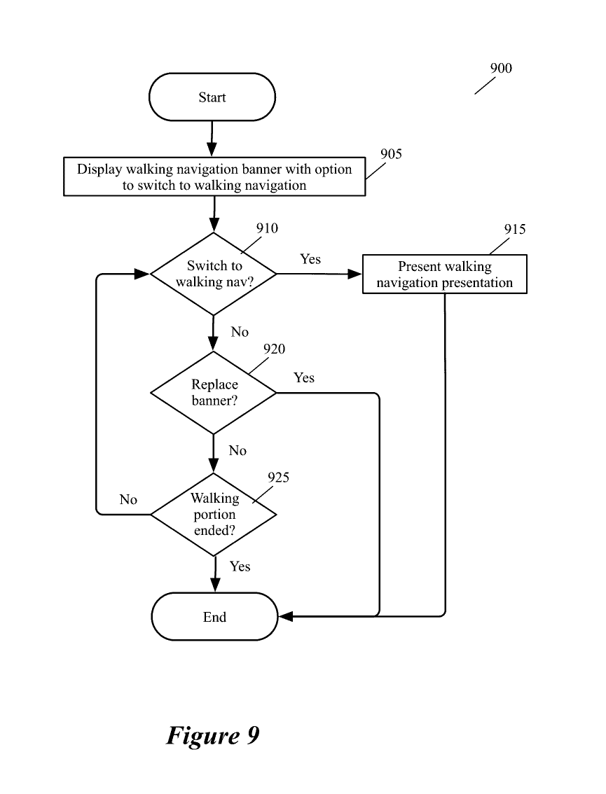

FIG. 9 conceptually illustrates a process 900 that describes the operation of the map application of some embodiments during the walking portion of a transit navigation presentation. A transit navigation presentation module of the map application in some embodiments performs this process. This process starts each time that the transit navigation presentation is on a walking portion of a transit route that is being navigated. As shown, the process 900 initially displays (at 905) a walking navigation banner for the walking portion. This banner includes a control to switch from the transit navigation presentation to a walking navigation presentation.

Next, the process determines (at 910) whether the control was selected to direct the application to switch to the walking navigation presentation. If so, the process transitions to 915 to direct a walking navigation presentation module of the map application to provide a walking navigation presentation, and then ends. On the other hand, when the process determines (at 910) that the control has not been selected, the process determines (at 915) whether the navigation banner for the walking portion of the transit route should be replaced with another banner (e.g., because of user's scrolling of the banner or because of the device's location). If so, the process ends.

Otherwise, the process determines (at 925) whether the walking portion of the transit route has ended. When the walking portion has ended, the process 900 ends. On the other hand, when the process determines (at 925) that the walking portion of the transit route has not ended, it transitions back to 910, which was described above.

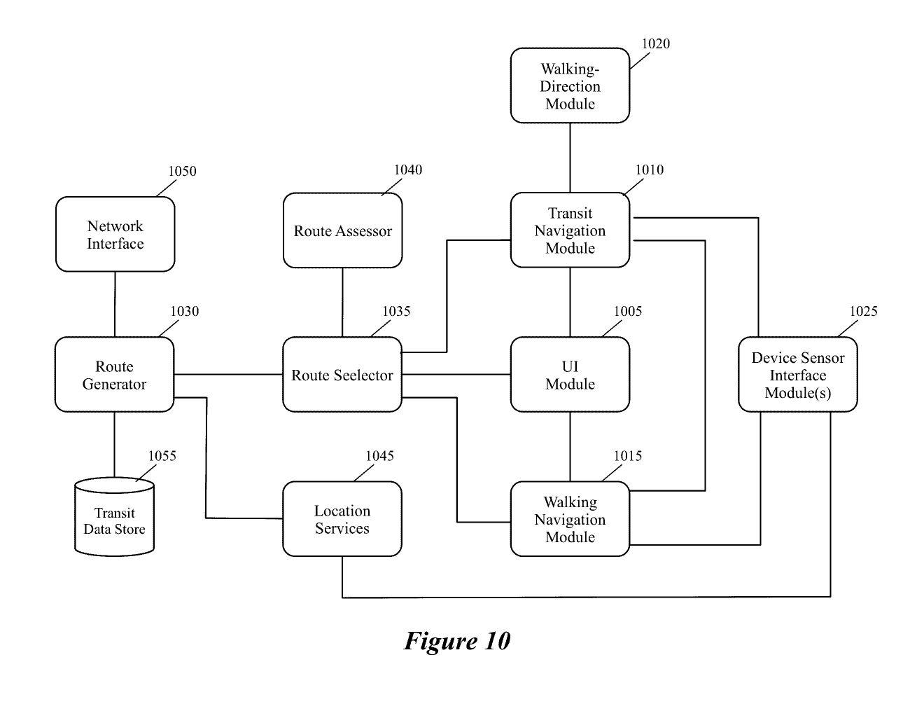

FIG. 10 illustrates several modules of the map application of some embodiments of the invention. These modules are responsible for providing and enabling the transit navigation presentation and the walking navigation presentation of some embodiments of the invention. As shown, these modules include a user interface module 1005, a transit navigation module 1010, a walking navigation module 1015, a walking direction module 1020, sensor interface modules 1025, a route generator 1030, a route selector 1035, a route assessor 1040, a location service module 1045, and a network interface module 1050.

The UI module provides the map display for browsing and searching. It also provides controls for requesting navigation presentations to particular destinations. The transit and walking navigation modules 1010 and 1015 respectively provide the transit and walking navigation presentations. As described above, these presentations are optimally designed to provide different navigation experiences and map views for transit navigation and walking navigation. Even though they provide fundamentally different navigation experiences, the transit and walking navigation modules 1010 and 1015 are part of one map application and hence provide seamless switching between these two fundamentally different navigation experiences.

The walking direction module 1020 defines the walking-direction indicators during the walking portions of a transit navigation presentation and provides this definition to the transit navigation module 1010. In some embodiments, the walking direction module performs the process 700 of FIG. 7. This module receives the device orientation data from one or more device sensors through the sensor interface module(s) 1025. The transit and walking navigation modules 1010 and 1015 also communicate with the sensor interface module(s) 1025 to receive location data and other motion sensor data that they need for their operations (e.g., to represent the position of the device in their map view, to ascertain that the device has moved to another leg of the transit or walking route, etc.). In other embodiment, these modules 1010 and 1015 obtain the data that they need from other modules, such as (1) the location service module 1045 that specifies the location of the device, and (2) an activity module (not shown) that uses sensor data to determine the device's current mode of transportation (e.g., walking, driving, biking, etc.).

FIG. 10 shows the transit and walking navigation modules 1010 and 1015 communicatively coupled in order to conceptually represent that the map application may switch between navigation presentations provided by these two modules. As mentioned above, the map application also includes a driving navigation presentation module (not shown) that provide a driving navigation presentation that provides a driving navigation guidance for navigating a route. The driving navigation presentation in some embodiments is designed differently than the transit and walking navigation presentations in order to provide yet another optimally designed navigation presentation that is defined for yet another mode of transportation.

The transit and walking navigation modules 1010 and 1015 obtain definitions of routes to navigate from the route selector 1035. From the UI module 1000, the route selector 1035 receives a request for a route between two locations. The route selector 1035 then directs the route generator 1030 to generate one or more routes between the two locations. The route generator in some embodiments generates a set of routes based on one or more local data stores (that includes a transit data store) that are periodically updated to include current map data. In some embodiments, the route generator 1030 uses one or more services that are external to the device to obtain one or more requested routes, or to obtain data from which the route generator can generator one or more requested routes. The route generator 1030 communicates with these services through the network interface 1050 of the device.

The route generator 1030 provides the set of one or more routes that it identifies to the route selector 1035, which then uses the route assessor to sort the provided routes into an order that quantifies the routes as best to worst based on a set of sorting criteria. The route selector then either provides the UI module 1000 with one route based on the sorting, or with several (e.g., three) routes based on the sorting. The UI module then presents the route(s) on the device, so that the user can review them and in some case request either a transit or walking navigation presentation to the destination. In some embodiments, the walking, transit, and driving navigation presentations to the same destination use different routes with different route definitions as different modes of transits are used to navigate the device to the destination in each of these presentations.

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

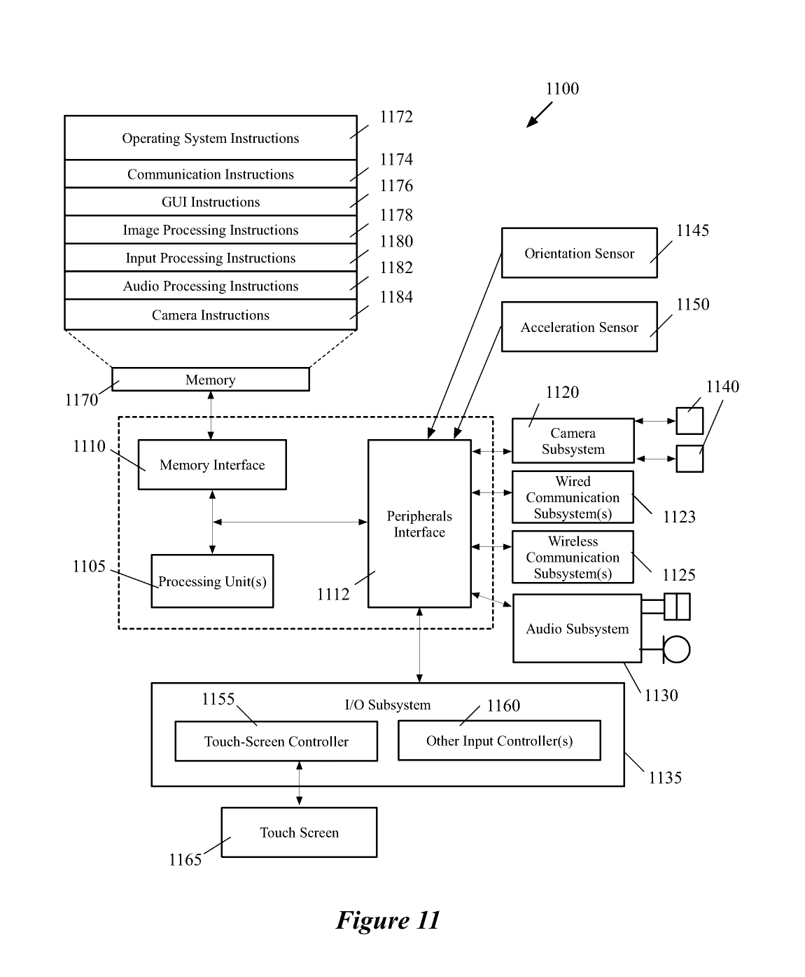

The applications of some embodiments operate on mobile devices, such as smart phones (e.g., iPhones®) and tablets (e.g., iPads®). FIG. 11 is an example of an architecture 1100 of such a mobile computing device. Examples of mobile computing devices include smartphones, tablets, laptops, etc. As shown, the mobile computing device 1100 includes one or more processing units 1105, a memory interface 1110 and a peripherals interface 1115.

The peripherals interface 1115 is coupled to various sensors and subsystems, including a camera subsystem 1120, a wireless communication subsystem(s) 1125, an audio subsystem 1130, an I/O subsystem 1135, etc. The peripherals interface 1115 enables communication between the processing units 1105 and various peripherals. For example, an orientation sensor 1145 (e.g., a gyroscope) and an acceleration sensor 1150 (e.g., an accelerometer) is coupled to the peripherals interface 1115 to facilitate orientation and acceleration functions.

The camera subsystem 1120 is coupled to one or more optical sensors 1140 (e.g., a charged coupled device (CCD) optical sensor, a complementary metal-oxide-semiconductor (CMOS) optical sensor, etc.). The camera subsystem 1120 coupled with the optical sensors 1140 facilitates camera functions, such as image and/or video data capturing. The wireless communication subsystem 1125 serves to facilitate communication functions. In some embodiments, the wireless communication subsystem 1125 includes radio frequency receivers and transmitters, and optical receivers and transmitters (not shown in FIG. 11). These receivers and transmitters of some embodiments are implemented to operate over one or more communication networks such as a GSM network, a Wi-Fi network, a Bluetooth network, etc. The audio subsystem 1130 is coupled to a speaker to output audio (e.g., to output voice navigation instructions). Additionally, the audio subsystem 1130 is coupled to a microphone to facilitate voice-enabled functions, such as voice recognition (e.g., for searching), digital recording, etc.

The I/O subsystem 1135 involves the transfer between input/output peripheral devices, such as a display, a touch screen, etc., and the data bus of the processing units 1105 through the peripherals interface 1115. The I/O subsystem 1135 includes a touch-screen controller 1155 and other input controllers 1160 to facilitate the transfer between input/output peripheral devices and the data bus of the processing units 1105. As shown, the touch-screen controller 1155 is coupled to a touch screen 1165. The touch-screen controller 1155 detects contact and movement on the touch screen 1165 using any of multiple touch sensitivity technologies. The other input controllers 1160 are coupled to other input/control devices, such as one or more buttons. Some embodiments include a near-touch sensitive screen and a corresponding controller that can detect near-touch interactions instead of or in addition to touch interactions.

The memory interface 1110 is coupled to memory 1170. In some embodiments, the memory 1170 includes volatile memory (e.g., high-speed random access memory), non-volatile memory (e.g., flash memory), a combination of volatile and non-volatile memory, and/or any other type of memory. As illustrated in FIG. 11, the memory 1170 stores an operating system (OS) 1172. The OS 1172 includes instructions for handling basic system services and for performing hardware dependent tasks.

The memory 1170 also includes communication instructions 1174 to facilitate communicating with one or more additional devices; graphical user interface instructions 1176 to facilitate graphic user interface processing; image processing instructions 1178 to facilitate image-related processing and functions; input processing instructions 1180 to facilitate input-related (e.g., touch input) processes and functions; audio processing instructions 1182 to facilitate audio-related processes and functions; and camera instructions 1184 to facilitate camera-related processes and functions. The instructions described above are merely exemplary and the memory 1170 includes additional and/or other instructions in some embodiments. For instance, the memory for a smartphone may include phone instructions to facilitate phone-related processes and functions. The above-identified instructions need not be implemented as separate software programs or modules. Various functions of the mobile computing device can be implemented in hardware and/or in software, including in one or more signal processing and/or application specific integrated circuits.

While the components illustrated in FIG. 11 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 11 may be split into two or more integrated circuits.

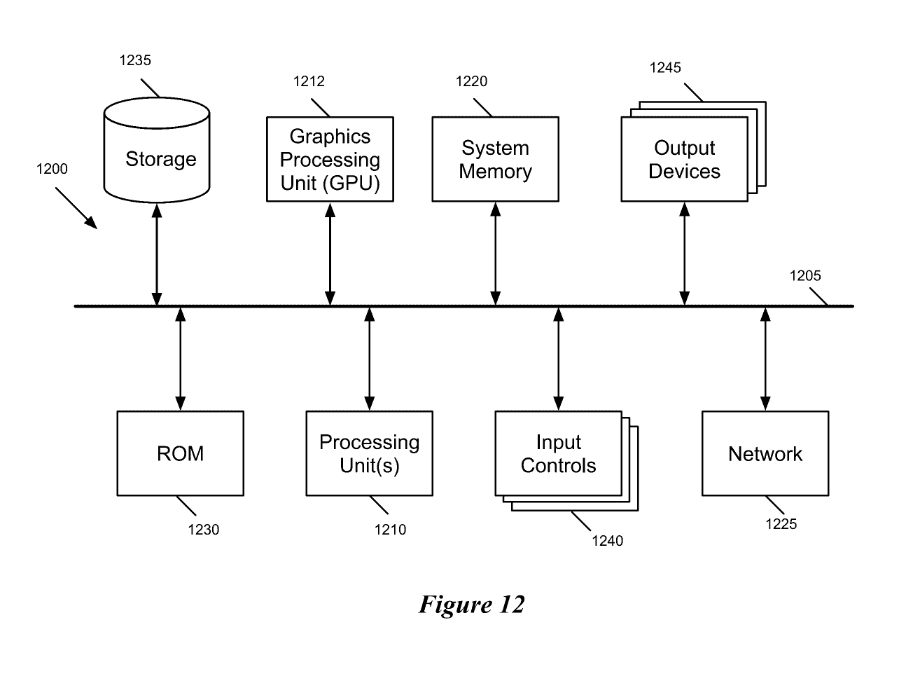

FIG. 12 conceptually illustrates another example of an electronic system 1200 with which some embodiments of the invention are implemented. The electronic system 1200 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 1200 includes a bus 1205, processing unit(s) 1210, a graphics processing unit (GPU) 1215, a system memory 1220, a network 1225, a read-only memory 1230, a permanent storage device 1235, input devices 1240, and output devices 1245.

The bus 1205 collectively represents all system, peripheral, and chipset buses that communicatively connect the numerous internal devices of the electronic system 1200. For instance, the bus 1205 communicatively connects the processing unit(s) 1210 with the read-only memory 1230, the GPU 1215, the system memory 1220, and the permanent storage device 1235.

From these various memory units, the processing unit(s) 1210 retrieves instructions to execute and data to process in order to execute the processes of the invention. The processing unit(s) may be a single processor or a multi-core processor in different embodiments. Some instructions are passed to and executed by the GPU 1215. The GPU 1215 can offload various computations or complement the image processing provided by the processing unit(s) 1210.

The read-only-memory (ROM) 1230 stores static data and instructions that are needed by the processing unit(s) 1210 and other modules of the electronic system. The permanent storage device 1235, on the other hand, is a read-and-write memory device. This device is a non-volatile memory unit that stores instructions and data even when the electronic system 1200 is off. Some embodiments of the invention use a mass-storage device (such as a magnetic or optical disk and its corresponding disk drive, integrated flash memory) as the permanent storage device 1235.

Other embodiments use a removable storage device (such as a floppy disk, flash memory device, etc., and its corresponding drive) as the permanent storage device. Like the permanent storage device 1235, the system memory 1220 is a read-and-write memory device. However, unlike storage device 1235, the system memory 1220 is a volatile read-and-write memory, such a random access memory. The system memory 1220 stores some of the instructions and data that the processor needs at runtime. In some embodiments, the invention's processes are stored in the system memory 1220, the permanent storage device 1235, and/or the read-only memory 1230. For example, the various memory units include instructions for processing multimedia clips in accordance with some embodiments. From these various memory units, the processing unit(s) 1210 retrieves instructions to execute and data to process in order to execute the processes of some embodiments.

The bus 1205 also connects to the input and output devices 1240 and 1245. The input devices 1240 enable the user to communicate information and select commands to the electronic system. The input devices 1240 include alphanumeric keyboards and pointing devices (also called “cursor control devices”), cameras (e.g., webcams), microphones or similar devices for receiving voice commands, etc. The output devices 1245 display images generated by the electronic system or otherwise output data. The output devices 1245 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 12, bus 1205 also couples electronic system 1200 to a network 1225 through a network adapter (not shown). In this manner, the computer can be a part of a network of computers (such as a local area network (“LAN”), a wide area network (“WAN”), or an Intranet), or a network of networks, such as the Internet. Any or all components of electronic system 1200 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

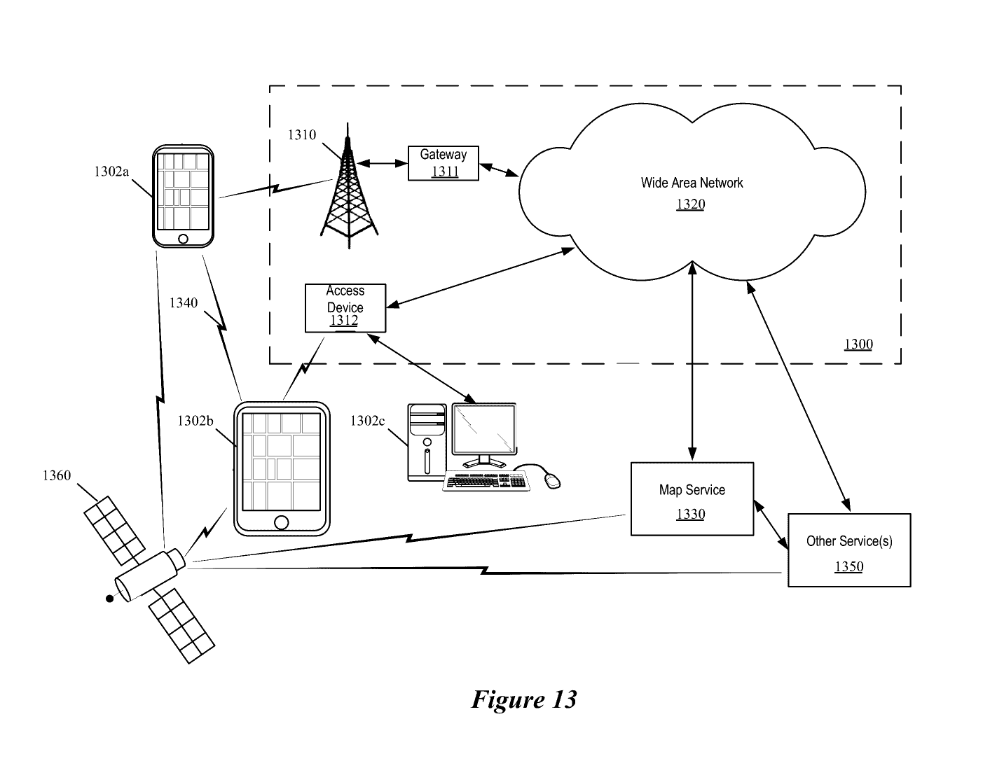

Various embodiments may operate within a map service operating environment. FIG. 13 illustrates one possible embodiment of an operating environment 1300 for a map service (also referred to as a mapping service) 1330 and client devices 1302a-1302c. In some embodiments, devices 1302a, 1302b, and 1302c communicate over one or more wired or wireless networks 1310. For example, wireless network 1310, such as a cellular network, can communicate with a wide area network (WAN) 1320, such as the Internet, by use of gateway 1314. A gateway 1314 in some embodiments provides a packet oriented mobile data service, such as General Packet Radio Service (GPRS), or other mobile data service allowing wireless networks to transmit data to other networks, such as wide area network 1320. Likewise, access device 1312 (e.g., IEEE 802.11g wireless access device) provides communication access to WAN 1320.

The client devices 1302a and 1302b can be any portable electronic or computing device capable of communicating with a map service (e.g., smart phone, tablet, laptop computer, etc.). Device 1302c can be any non-portable electronic or computing device capable of communicating with a map service (e.g., desktop computer, etc.). These devices may be multifunction devices capable of various functions (e.g., placing phone calls, sending electronic messages, producing documents, etc.). Though the devices 1302a-1302c are not shown as each accessing the map service 1330 via either the wireless network 1310 and gateway 1314 or the access device 1312, one of ordinary skill in the art will recognize that the client devices of some embodiments may access the map service via multiple different wired and/or wireless protocols.

Devices 1302a-1302c can also establish communications by other means. For example, these devices may communicate with other wireless devices (e.g., other devices 1302b, cell phones, etc.) over the wireless network 1310 or through access device 1312. Likewise the devices 1302a-1302c can establish peer-to-peer communications 1340 (e.g., a personal area network) by use of one or more communication subsystems, such as Bluetooth® communication or similar peer-to-peer protocols.

Devices 1302a-1302c may also receive Global Positioning Satellite (GPS) signals from GPS satellites 1360. In addition, in some embodiments the map service 1330 and other services 1350 may also receive GPS signals from GPS satellites 1360.

A map service 1330 may provide map services for one or more client devices 1302a-1302c in communication with the map service 1330 through various communication methods and protocols. A map service 1330 in some embodiments provides map information (e.g., map tiles used by the client devices to generate a two-dimensional or three-dimensional map presentation) and other map-related data, such as two-dimensional map image data (e.g., aerial view of roads utilizing satellite imagery), three-dimensional map image data (e.g., traversable map with three-dimensional features, such as buildings), route and direction calculations (e.g., driving route data, ferry route calculations, directions between two points for a pedestrian, etc.), real-time navigation data (e.g., turn-by-turn visual navigation data in two or three dimensions), traffic data, location data (e.g., where the client device currently is located), and other geographic data (e.g., wireless network coverage, weather, traffic information, or nearby points-of-interest). In various embodiments, the map service data may include localized labels for different countries or regions. Localized labels may be utilized to present map labels (e.g., street names, city names, points of interest) in different languages on client devices. The client devices 1302a-1302c may utilize these map services to obtain the various map service data, then implement various techniques to process the data and provide the processed data to various entities (e.g., internal software or hardware modules, display screens of the client devices, external display screens, or other external systems or devices.

The map service 1330 of some embodiments provides map services by generating and distributing the various types of map service data listed above, including map information used by the client device to generate and display a map presentation. In some embodiments, the map information includes one or more map tiles. The map tiles may include raster image data (e.g., bmp, gif, jpg/jpeg/, png, tiff, etc. data) for display as a map presentation. In some embodiments, the map tiles provide vector-based map data, with the map presentation data encoded using vector graphics (e.g., svg or drw data). The map tiles may also include various other information pertaining to the map, such as metadata. Some embodiments also encode style data (e.g., used to generate textures) into the map tiles. The client device processes (e.g., renders) the vector and/or raster image data to generate a map presentation for display as a two-dimensional or three-dimensional map presentation. To transmit the map tiles to a client device 1302a-1302c, the map service 1330 of some embodiments, performs various optimization techniques to analyze a map tile before encoding the tile.

In some embodiments, the map tiles are generated by the map service 1330 for different possible display resolutions at the client devices 1302a-1302c. In some embodiments, the higher zoom levels may include more detail (e.g., more street level information, etc.). On the other hand, map tiles for lower zoom levels may omit certain data (e.g., the street level details would not be used when displaying the entire earth).

To generate the map information (e.g., map tiles), the map service 1330 may obtain map service data from internal or external sources. For example, satellite imagery used in map image data may be obtained from external services, or internal systems, storage devices, or nodes. Other examples may include, but are not limited to, GPS assistance servers, wireless network coverage databases, business or personal directories, weather data, government information (e.g., construction updates or road name changes), or traffic reports. Some embodiments of a map service may update map service data (e.g., wireless network coverage) for analyzing future requests from client devices.

In some embodiments, the map service 1330 responds to requests from the client devices 1302a-1302c for map information. The client devices may request specific portions of a map, or specific map tiles (e.g., specific tiles at specific zoom levels). In some embodiments, the client devices may provide the map service with starting locations (or current locations) and destination locations for a route calculations, and request turn-by-turn navigation data. A client device may also request map service rendering information, such as map textures or style sheets. Requests for other geographic data may include, but are not limited to, current location, wireless network coverage, weather, traffic information, or nearby points-of-interest.

The client devices 1302a-1302c that obtain map service data from the map service 1330 and render the data to display the map information in two-dimensional and/or three-dimensional views. Some embodiments display a rendered map and allow a user, system, or device to provide input to manipulate a virtual camera for the map, changing the map display according to the virtual camera's position, orientation, and field-of-view. Various forms and input devices are implemented to manipulate a virtual camera. In some embodiments, touch input, through certain single or combination gestures (e.g., touch-and-hold or a swipe) manipulate the virtual camera. Other embodiments allow manipulation of the device's physical location to manipulate a virtual camera. Other input devices to the client device may be used including, e.g., auditory input (e.g., spoken words), a physical keyboard, mouse, and/or a joystick. Some embodiments provide various visual feedback to virtual camera manipulations, such as displaying an animation of possible virtual camera manipulations when transitioning from two-dimensional map views to three-dimensional map views.

In some embodiments, a client device 1302a-1302c implements a navigation system (e.g., turn-by-turn navigation), which may be part of an integrated mapping and navigation application. A navigation system provides directions or route information, which may be displayed to a user. As mentioned above, a client device may receive both map image data and route data from the map service 1330. In some embodiments, the navigation feature of the client device provides real-time route and direction information based upon location information and route information received from a map service and/or other location system, such as a Global Positioning Satellite (GPS) system. A client device may display map image data that reflects the current location of the client device and update the map image data in real-time. The navigation features may provide auditory or visual directions to follow a certain route, and some embodiments display map data from the perspective of a virtual camera biased toward the route destination during turn-by-turn navigation.

The client devices 1302a-1302c of some embodiments implement various techniques to utilize the received map service data (e.g., optimized rendering techniques). In some embodiments, a client device locally stores some of the information used to render map data. For instance, client devices may store style sheets with rendering directions for image data containing style identifiers, common image textures (in order to decrease the amount of map image data transferred from the map service), etc. The client devices of some embodiments may implement various techniques to render two-dimensional and three-dimensional map image data, including, e.g., generating three-dimensional buildings out of two-dimensional building footprint data; modeling two-dimensional and three-dimensional map objects to determine the client device communication environment; generating models to determine whether map labels are seen from a certain virtual camera position; and generating models to smooth transitions between map image data.

In various embodiments, map service 1330 and/or other service(s) 1350 are configured to process search requests from any of the client devices. Search requests may include but are not limited to queries for businesses, addresses, residential locations, points of interest, or some combination thereof. Map service 1330 and/or other service(s) 1350 may be configured to return results related to a variety of parameters including but not limited to a location entered into an address bar or other text entry field (including abbreviations and/or other shorthand notation), a current map view (e.g., user may be viewing one location on the multifunction device while residing in another location), current location of the user (e.g., in cases where the current map view did not include search results), and the current route (if any). In various embodiments, these parameters may affect the composition of the search results (and/or the ordering of the search results) based on different priority weightings. In various embodiments, the search results that are returned may be a subset of results selected based on specific criteria including but not limited to a quantity of times the search result (e.g., a particular point of interest) has been requested, a measure of quality associated with the search result (e.g., highest user or editorial review rating), and/or the volume of reviews for the search results (e.g., the number of times the search result has been review or rated).

In various embodiments, map service 1330 and/or other service(s) 1350 are configured to provide auto-complete search results that are displayed on the client device, such as within the mapping application. For instance, auto-complete search results may populate a portion of the screen as the user enters one or more search keywords on the multifunction device. In some cases, this feature may save the user time as the desired search result may be displayed before the user enters the full search query. In various embodiments, the auto complete search results may be search results found by the client on the client device (e.g., bookmarks or contacts), search results found elsewhere (e.g., from the Internet) by map service 1330 and/or other service(s) 1350, and/or some combination thereof. As is the case with commands, any of the search queries may be entered by the user via voice or through typing. The multifunction device may be configured to display search results graphically within any of the map display described herein. For instance, a pin or other graphical indicator may specify locations of search results as points of interest. In various embodiments, responsive to a user selection of one of these points of interest (e.g., a touch selection, such as a tap), the multifunction device is configured to display additional information about the selected point of interest including but not limited to ratings, reviews or review snippets, hours of operation, store status (e.g., open for business, permanently closed, etc.), and/or images of a storefront for the point of interest. In various embodiments, any of this information may be displayed on a graphical information card that is displayed in response to the user's selection of the point of interest.

In various embodiments, map service 1330 and/or other service(s) 1350 provide one or more feedback mechanisms to receive feedback from client devices 1302a-1302c. For instance, client devices may provide feedback on search results to map service 1330 and/or other service(s) 1350 (e.g., feedback specifying ratings, reviews, temporary or permanent business closures, errors etc.); this feedback may be used to update information about points of interest in order to provide more accurate or more up-to-date search results in the future. In some embodiments, map service 1330 and/or other service(s) 1350 may provide testing information to the client device (e.g., an A/B test) to determine which search results are best. For instance, at random intervals, the client device may receive and present two search results to a user and allow the user to indicate the best result. The client device may report the test results to map service 1330 and/or other service(s) 1350 to improve future search results based on the chosen testing technique, such as an A/B test technique in which a baseline control sample is compared to a variety of single-variable test samples in order to improve results.

While the invention has been described with reference to numerous specific details, one of ordinary skill in the art will recognize that the invention can be embodied in other specific forms without departing from the spirit of the invention. For instance, many of the figures illustrate various touch gestures. However, many of the illustrated operations could be performed via different touch gestures (e.g., a swipe instead of a tap, etc.) or by non-touch input (e.g., using a cursor controller, a keyboard, a touchpad/trackpad, a near-touch sensitive screen, etc.). In addition, a number of the figures conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. One of ordinary skill in the art would understand that the invention is not to be limited by the foregoing illustrative details, but rather is to be defined by the appended claims.

What is claimed is:

1. A device comprising:
a set of processing units for executing sets of instructions; and
a non-transitory machine readable medium storing a navigation application which when executed by at least one of the processing units provides a navigation presentation, the navigation application comprising sets of instructions for:
as the device traverses a transit route, providing a transit navigation presentation that includes navigation instructions that specify navigation maneuvers associated with at least one walking portion and a set of transit vehicles;
monitoring the device's position along the transit route; and
after determining that the device is on the walking portion of the transit route, automatically, and without user intervention, presenting a walking-direction indicator to identify the orientation of the device with respect to a desired walking-navigation direction of the walking portion of the route.

2. The device of claim 1, wherein the walking-navigation direction of the particular walking portion changes more than once as the device traverses the walking portion, wherein as the walking-navigation direction changes, the device's orientation needs to be modified to align the orientation of the device with the desired walking direction.

3. The device of claim 1, wherein the walking-direction indicator has a range indicator that provides a range of potential orientations of the device.

4. The device of claim 3 further comprising a compass that requires calibration, wherein the range is a wider range when the compass is less calibrated, wherein as the compass improves its calibration, the provided range narrows.

5. The device of claim 1, wherein the walking-direction indicator has a first direction identifier that points in the direction that specifies the orientation of the device.

6. The device of claim 5, wherein the walking-direction indicator has a second direction identifier that points to a fixed geographic direction.

7. A method of providing a navigation presentation on a device, the method comprising:
as the device traverses a transit route, providing a transit navigation presentation that includes navigation instructions that specify navigation maneuvers associated with at least one walking portion and a set of transit vehicles;
monitoring the device's position along the transit route; and
after determining that the device is on the walking portion of the transit route, automatically, and without user intervention, presenting a walking-direction indicator to identify the orientation of the device with respect to a desired walking-navigation direction of the walking portion of the route.

8. The method of claim 7, wherein the walking-navigation direction of the particular walking portion changes more than once as the device traverses the walking portion, wherein as the walking-navigation direction changes, the device's orientation needs to be modified to align the orientation of the device with the desired walking direction.

9. The method of claim 7, wherein the walking-direction indicator has a range indicator that provides a range of potential orientations of the device.

10. The method of claim 9, wherein the device comprises a compass that requires calibration, the method further comprising narrowing the range as the device moves and the compass improves its calibration.

11. The method of claim 7, wherein the walking-direction indicator has a first direction identifier that points in the direction that specifies the orientation of the device.

12. The method of claim 11, wherein the walking-direction indicator has a second direction identifier that points to a fixed geographic direction.

13. A device comprising:
a set of processing units for executing sets of instructions; and
a non-transitory machine readable medium storing a navigation application which when executed by at least one of the processing units provides a navigation presentation, the navigation application comprising sets of instructions for:
as the device traverses a transit route, providing a transit navigation presentation that includes navigation banners that describe navigation maneuvers associated with at least one walking portion and a set transit of vehicles, wherein a particular navigation banner relates to the walking portion and includes an affordance for directing the navigation to switch from the transit navigation presentation to a walking navigation presentation for the walking portion; and
providing the walking navigation presentation for the walking portion upon selection of the affordance.

14. The device of claim 13, wherein the transit navigation presentation is one navigation mode that is designed for a transit navigation experience, while the walking navigation presentation is another navigation mode that is designed for a walking navigation experience.

15. The device of claim 13, wherein the walking navigation presentation provides turn-by-turn guidance along the walking portion, while the transit navigation presentation does not provide turn-by-turn guidance at walking junctures along the walking portion.

16. The device of claim 13, wherein the navigation application further comprises a set of instructions for providing an affordance during the walking presentation to switch back to the transit presentation.

17. The device of claim 13, wherein the navigation application further comprises a set of instructions for monitoring the device's position as the device traverses along the route.

18. The device of claim 17, wherein the navigation application further comprises sets of instructions for:
during the walking navigation presentation, detecting that the device has reached the end of the walking portion; and
automatically, without input from outside of the device, switching back to the transit navigation presentation after detecting that the device has reached the end of the walking portion.

19. The device of claim 13 further comprising a display screen for displaying the transit navigation presentation.
